(19) United States
(12) Patent Application Publication
(10) Pub. No.: US 2014/0133796 A1
(43) Pub. Date: May 15, 2014

(54) Apparatus For Providing Polarization Rotation

(71) Applicant: Po Dong, Morganville, NJ (US)

(72) Inventor: Po Dong, Morganville, NJ (US)

(21) Appl. No.: 13/676,469

(22) Filed: Nov. 14, 2012

(51) Int. Cl. G02B 6/10

(52) U.S. Cl. CPC G02B 6/10
USPC 385/11

(57) ABSTRACT

Various embodiments provide a waveguide-based polarization rotator that comprises top and bottom claddings of substantially the same material. In some embodiments, the waveguide-based polarization rotator converts between Transverse Electric (TE) and Transverse Magnetic (TM) modes.

### TECHNICAL FIELD

The invention relates generally to apparatus for providing polarization rotation.

### BACKGROUND

This section introduces aspects that may be helpful in facilitating a better understanding of the inventions. Accordingly, the statements of this section are to be read in this light and are not to be understood as admissions about what is in the prior art or what is not in the prior art.

In some known constructions of polarization rotators, asymmetric claddings are used with silicon waveguides. For example, the cladding on one side of the waveguide may be an oxide and the cladding on the opposite side of the waveguide the waveguide may be SiN or air.

### SUMMARY OF ILLUSTRATIVE EMBODIMENTS

Some simplifications may be made in the following summary, which is intended to highlight and introduce some aspects of the various exemplary embodiments, but such simplifications are not intended to limit the scope of the inventions. Detailed descriptions of a preferred exemplary embodiment adequate to allow those of ordinary skill in the art to make and use the inventive concepts will follow in later sections

Various embodiments provide a waveguide-based polarization rotator that comprises top and bottom claddings of the same material. In some embodiments, the waveguide-based polarization rotator converts between Transverse Electric (TE) and Transverse Magnetic (TM) modes. The term “TE” as used herein refers to TE-dominated modes and the term “TM” as used herein refers to TM-dominated modes.

In one embodiment, an apparatus is provided for providing polarization rotation. The apparatus includes a first cladding layer; a slab including a first side and a second side, the first side disposed on the first cladding layer; a plurality of waveguide cores contiguous to the slab, the plurality of waveguide cores are configured to convert light from a first light mode to a second different light mode over an optical path; and a second cladding layer disposed on the second side and the slab. Wherein the first and second cladding layers are comprised of substantially the same material.

In some of the above embodiments, the slab is configured to have a slab extension width that is ≧0.05 um.

In some of the above embodiments, the slab is configured to have a slab extension width that is estimated to exceed waveguide mode.

In some of the above embodiments, the slab is configured to have a slab extension width that completely separates the first cladding layer from the second cladding layer.

In some of the above embodiments, the slab and the plurality of waveguide cores are at least a portion of a rib or ridge waveguide.

In some of the above embodiments, the first light mode comprises one of transverse electric mode and transverse magnetic mode and the second light mode comprises one of transverse electric mode and transverse magnetic mode.

In some of the above embodiments, the first and second cladding layers are separated by the slab or the plurality of waveguide cores.

In some of the above embodiments, the plurality of waveguide cores includes a first waveguide core and a second waveguide core optically coupled to the first waveguide core. The first waveguide core includes: a first segment, the first segment having a first segment width; a third segment, the third segment having the third segment width; and a second segment disposed between the first segment and the third segment, the second segment tapered between the first segment width and a third segment width. The waveguide core includes: a fourth segment, the fourth segment having a fourth segment width.

In some of the above embodiments, the third segment is optically coupled to the fourth segment.

In some of the above embodiments, the second segment is configured to convert light between TM0 and TE1 modes and the third segment and fourth segment are configured to convert light between TE1 and TE0 modes.

In some of the above embodiments, the plurality of waveguide cores includes a first waveguide core and a second waveguide core optically coupled to the first waveguide core. The first waveguide core includes: a first segment, the first segment having a first segment width; a third segment, the third segment tapered between the third segment left width and a third segment right width; and a second segment disposed between the first segment and the third segment, the second segment tapered between the first segment width and a third segment left width. The second waveguide core includes: a fourth segment, the fourth segment tapered between a fourth segment left width and a fifth segment width; and a fifth segment disposed further from the first waveguide core on the optical path as compared to the fourth segment, the fifth segment having the fifth segment width.

In some of the above embodiments, the third segment is optically coupled to the fourth segment.

In some of the above embodiments, the second segment is configured to convert light between TM0 and TE1 modes and the third segment and fourth segment are configured to convert light between TE1 and TE0 modes.

In some of the above embodiments, the plurality of waveguide cores includes: a first waveguide core comprising a first segment, the first segment having a first segment width; and a second waveguide core having a second segment, the second segment optically coupled to the first segment, and the second segment having a second segment width.

In some of the above embodiments, the first segment and second segments are configured to convert light between TM0 and TE0 modes.

In some of the above embodiments, the plurality of waveguide cores includes a first waveguide core and a second waveguide core optically coupled to the first waveguide core. The first waveguide core includes: a first segment, the first segment having a first segment width; and a second segment disposed closer to the second waveguide core on the optical path as compared to the first segment, the second segment tapered between the first segment width and a second segment right width. The second waveguide core includes: a third segment, the third segment tapered between a third segment left width and a fourth segment width; and a fourth segment disposed further from the first waveguide core on the optical path as compared to the third segment, the fourth segment having a fourth segment width.

In some of the above embodiments, the second segment is optically coupled to the third segment.

In some of the above embodiments, the second segment and third segment are configured to convert light between TM0 and TE0 modes.

In a second embodiment, an apparatus is provided for providing polarization rotation. The apparatus includes: a first cladding layer; a rib or ridge waveguide, and a second cladding layer disposed on the second side and the slab. The rib or ridge waveguide includes: a slab including a first side and a second side, the first side disposed on the first cladding layer; and a plurality of waveguide cores contiguous to the slab, the plurality of waveguide cores being configured to convert light from a first light mode to a second different light mode over an optical path. Wherein the first light mode comprises one of transverse electric mode and transverse magnetic mode and the second light mode comprises one of transverse electric mode and transverse magnetic mode; and wherein the first and second cladding layers comprise substantially the same material.

### BRIEF DESCRIPTION OF THE DRAWINGS

Various embodiments are illustrated in the accompanying drawings, in which:

FIG. 1a depicts a cross section 100a that is an exemplary cross section of an embodiment of a waveguide-based polarization rotator;

FIG. 1 b depicts a cross section 100b that is another exemplary cross section of an embodiment of a waveguide-based polarization rotator;

FIG. 2 depicts a block diagram of the top view 200 of a plurality of waveguide cores that is one embodiment of the top view of the plurality of waveguide cores 140-1 and 140-2 of FIG. 1;

FIG. 3 depicts a block diagram of the top view 300 of a plurality of waveguide cores that is one embodiment of the top view of the plurality of waveguide cores 140-1 and 140-2 of FIG. 1;

FIG. 4 depicts a block diagram of the top view 400 of a plurality of waveguide cores that is one embodiment of the top view of the plurality of waveguide cores 140-1 and 140-2 of FIG. 1; and

FIG. 5 depicts a block diagram of the top view 500 of a plurality of waveguide cores that is one embodiment of the top view of the plurality of waveguide cores 140-1 and 140-2 of FIG. 1.

To facilitate understanding, identical reference numerals have been used to designate elements having substantially the same or similar structure or substantially the same or similar function.

### DETAILED DESCRIPTION OF ILLUSTRATIVE EMBODIMENTS

The description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

Various embodiments provide a waveguide-based polarization rotator that comprises top and bottom claddings of substantially the same material. In some embodiments, the waveguide-based polarization rotator converts Transverse Electric (TE) to Transverse Magnetic (TM) modes of the waveguides (or vice vesa).

Advantageously, by having top and bottom claddings constructed of the same materials, an additional material/layer may not be required to achieve polarization rotation. Moreover, the waveguide-based polarization rotator may be constructed using simple fabrications such as one-time lithograph and one-time etching and the waveguide-based polarization rotator may be integrated on the same platform with other photonic devices such as variable optical attenuators, power monitors, high speed modulators and photo detectors.

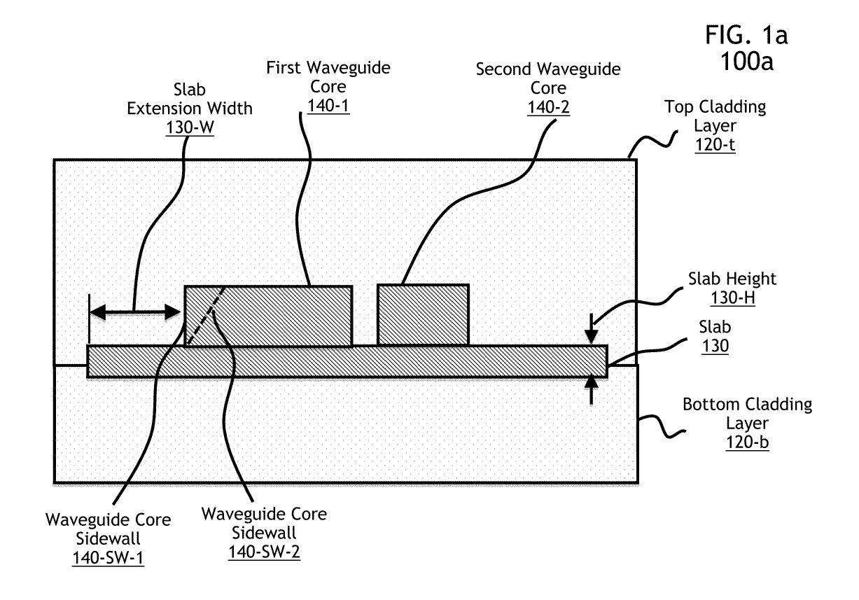

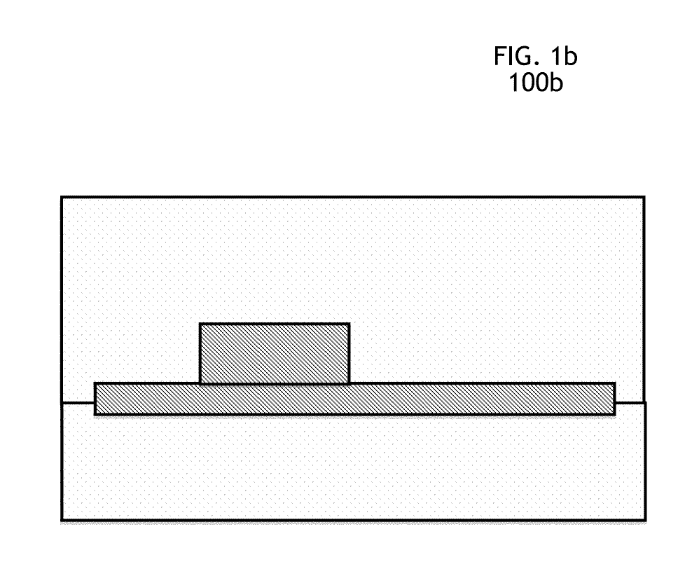

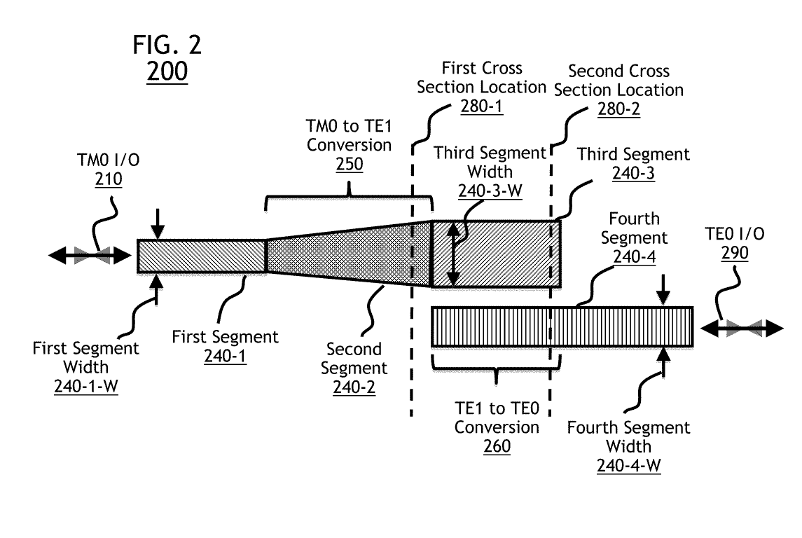

FIG. 1a depicts a cross section 100a that is an exemplary cross section of an embodiment of a waveguide-based polarization rotator. As illustrated in cross section 100a, the waveguide-based polarization rotator includes top and bottom cladding layers 120-t and 120-b (collectively, cladding layers 120), a slab 130, and a plurality of waveguide cores 140-1 and 140-2. It should be appreciated that cross sections of the waveguide-based polarization rotator are not uniform. In particular, referring to FIGS. 2-5 which illustrate the top view of a number of embodiments of the plurality of waveguide cores of the waveguide-based polarization rotator, it should be appreciated that the cross section of the plurality of waveguide cores will differ depending on the location of the cross section. For example, referring to FIG. 2, waveguide-based polarization rotator cross section 100a of FIG. 1a may illustrate a cross section taken at second cross section location 280-2 of FIG. 2. Similarly, waveguide-based polarization rotator cross section 100b of FIG. 1 b may illustrate a cross section taken at first cross section location 280-1 of FIG. 2.

Top and bottom cladding layers 120-t and 120-b comprise a material having substantially the same refractive index. Cladding layers 120 may include any suitable materials having a refractive index lower than the waveguide core materials. It should be appreciated that the boundary between top and bottom cladding layers 120-t and 120-b are for illustrative purposes and that top and bottom cladding layers 120-t and 120-b may be fabricated as a single cladding material.

As used herein, the term “substantially” refers to a tolerance of less or equal to ten percent (10%).

Slab 130 is configured to break the vertical asymmetry of the waveguide-based polarization rotator and may include any suitable high-index-contrast material. In particular, slab 130 is arranged between at least a portion of the top and bottom cladding layers 120-t and 120-b. Slab extension width 130-W may be any width suitable to break the vertical asymmetry of the waveguide core. It should be appreciated that while only slab extension width 130-W is labeled here, slab extensions may be required on either side of each of the plurality of waveguide cores in order to break the vertical asymmetry of the waveguide core. It should be further appreciated that slab extension width 130-W may vary across a cross section or for different cross sections of the waveguide-based polarization rotator and that the slab extension width 130-W on the opposing sides of the waveguide core or on a different waveguide core may differ. It should be appreciated that additional layers such as waveguide core 140 may separate the top and bottom cladding layers 120-t and 120-b. It should be further appreciated that portions of top and bottom cladding layers 120-t and 120-b may be contiguous.

The plurality of waveguide cores 140-1 and 140-2 may include any suitable high-index-contrast material. In particular, the plurality of waveguide cores provides an optical path and is configured to convert light traversing the optical path between a first mode and a second mode. Any suitable configuration of the plurality of waveguide cores that convert light between the first mode and second mode may be used. In some embodiments, the first and second modes may be Transverse Electric (TE) and Transverse Magnetic (TM) modes. It should be appreciated that each of the waveguide cores may be positioned anywhere on slab 130 and that such position may differ between two different cross sections of the waveguide-based polarization rotator. It should be appreciated that while two waveguide cores are illustrated here, system 100 may include more waveguide cores.

In some embodiments, a conventional rib or ridge waveguide may include slab 130 and at least one of the plurality of waveguide cores 140-1 and 140-2.

In some embodiments, slab 130 has a slab height 130-h. In some of these embodiments, slab height 130-h is substantially uniform across slab 130.

In some embodiments, slab height 130-h is between a 2 nanometers and 2 micron meters.

In some embodiments, throughout a substantial portion of the slab 130, slab extension width 130-W is between a threshold value estimated to exceed waveguide mode (i.e., electromagnetic field pattern of radiation measured in a plane perpendicular to the propagation direction of the beam) and a value extending to the edge of the waveguide-based polarization rotator. In some of these embodiments, the threshold value is 0.05 um for at least a portion of at least one of the plurality of waveguide cores 140-1 and 140-2. In some of these embodiments, the threshold value is 0 for at least some portions of at least one or more of plurality of waveguide cores 140-1 and 140-2.

In some embodiments, slab extension width 130-W extends to the edge of the waveguide-based polarization rotator and separates top and bottom cladding layers 120-t and 120-b throughout a substantial portion of the slab 130.

In some embodiments, the top and bottom cladding layers 120-t and 120-b are both oxide. Advantageously, the use of oxide as cladding is compatible with other silicon optical devices such as modulators, attenuators and detectors and may enable collocation of the waveguide-based polarization rotator with other silicon optical devices.

In some embodiments, slab 130 or the plurality of waveguide cores (e.g., waveguide core 140) are silicon.

In some embodiments, slab 130 or the plurality of waveguide cores (e.g., waveguide core 140) are silicon nitride.

In some embodiments, slab 130 or the plurality of waveguide cores (e.g., waveguide core 140) are InP.

In some embodiments, slab 130 and the plurality of waveguide cores (e.g., waveguide core 140) are substantially the same material.

In some embodiments, the sidewall (e.g., waveguide core sidewall 140-SW-1) is substantially perpendicular to the surface of slab 130. In some embodiments, one or both of the sidewalls (e.g., waveguide core sidewall 140-SW-2) may have a sidewall slope. The sidewall slope may be any suitable waveguide parameter. In some embodiments, the slope is between 45 degrees and 135 degrees.

FIG. 2 depicts a block diagram of the top view 200 of a plurality of waveguide cores that is one embodiment of the top view of the plurality of waveguide cores 140-1 and 140-2 of FIG. 1. The plurality of waveguide cores includes a first waveguide core and a second waveguide core that are configured to achieve polarization rotation over an optical path (e.g., between TM0 I/O 210 and TE0 I/O 290). The first waveguide core includes three (3) segments: 240-1, 240-2, and 240-3 and the second waveguide core includes one (1) segment: 240-4. In particular, segment widths 240-1-W, 240-3-W and 240-4-W (collectively, segment widths 240-W) may be configured to achieve polarization rotation. In some embodiments, the plurality of waveguide cores is configured to convert light between fundamental TM and TE modes.

As used herein, fundamental TM and TE modes are designated by TM0 and TE0 respectively. Similarly, first order TM and TE modes are designated by TM1 and TE1 respectively.

Polarization rotation occurs over conversion regions 250 and 260. First, conversion between TM0 mode and TE1 mode occurs over conversion region 250 due to the taper of second segment 240-2 between first segment width 240-1-W and third segment width 240-3-W. It should be appreciated that at segment width 240-1-W, the effective index of the TM0 mode is larger than the effective index of TE1 and when the segment width is increased from 240-1-W to 240-3-W, the effective index of TM0 becomes smaller than that of TE1. The mode conversion occurs adiabatically due to the refractive index difference change between these two modes. Segment widths 240-1-W and 240-3-W may be any suitable widths that provide TM0 to TE1 mode conversion. In some embodiments, 240-1-W may be 0.3 um to 1 um, while 240-3-W may be 0.5 um to 1.5 um.

Second, conversion between TE1 mode and TE0 mode occurs over conversion region 260 due to the optical coupling between third segment 240-3 and fourth segment 240-4. In particular, segment width 240-3-W of third segment 240-3 and segment width 240-4-W of fourth segment 240-4 are configured such that the effective index of TE1 mode of third segment 240-3 is the same as that of TE0 mode of fourth segment 240-4. Segment widths 240-3-W and 240-4-W may be any suitable widths that provide TE1 to TE0 mode conversion. In some embodiments, segment width 240-3-W may be 0.5 um to 1.5 um, while segment width 240-4-W may be 0.3 to 1 um. It should be appreciated that the gap between third segment 240-3 and fourth segment 240-4 over conversion region 260 may be any distance suitable that provides optical coupling.

It should be appreciated that if light is inputted via TM0 I/O 210 and outputted via TE0 I/O 290, TM0 to TE0 conversion takes place. Similarly, if light is inputted via TE0 I/O 290 and outputted via TM0 I/O 210, TE0 to TM0 conversion takes place.

It should be appreciated that since the lengths of segments 240 do not contribute to the polarization rotation, the lengths of each of segments 240 may be any suitable length.

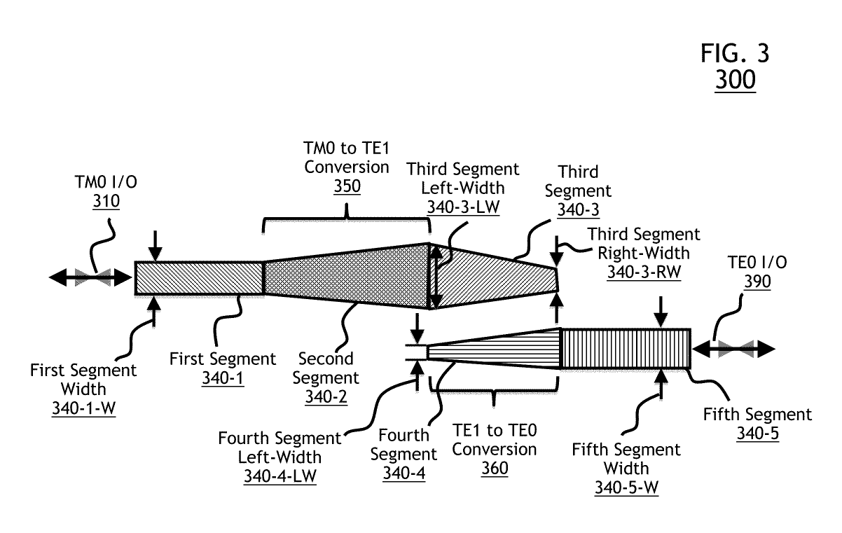

FIG. 3 depicts a block diagram of the top view 300 of a plurality of waveguide cores that is one embodiment of the top view of the plurality of waveguide cores 140-1 and 140-2 of FIG. 1. The plurality of waveguide cores includes a first waveguide core and a second waveguide core that are configured to achieve polarization rotation over an optical path (e.g., between TM0 I/O 310 and TE0 I/O 390). The first waveguide core includes three (3) segments: 340-1, 340-2, and 340-3 and the second waveguide core includes two (2) segments: 340-4 and 340-5. In particular, segment widths 340-1-W, 340-3-LW, 340-3-RW, 340-4-LW and 340-5-W (collectively, segment widths 340-W) may be configured to achieve polarization rotation. In some embodiments, the plurality of waveguide cores is configured to convert light between fundamental TM0 and TE0 modes.

Polarization rotation occurs over conversion regions 350 and 360. First, as described for conversion region 250 in FIG. 2, conversion between TM0 mode and TE1 mode occurs over conversion region 350 due to the taper of second segment 340-2 between first segment width 340-1-W and third segment width 340-3-LW.

Second, similar to the description for conversion region 260 in FIG. 2, conversion between TE1 mode and TE0 mode occurs over conversion region 360 due to the optical coupling between third segment 240-3 and fourth segment 240-4. Additional to third segment 240-3 and fourth segment 240-4 in FIG. 2, third segment 340-3 tapers between segment widths 340-3-LW and 340-3-RW and fourth segment 340-4 tapers between segment widths 340-4-LW and 340-5-W to facilitate the coupling between TE1 mode and TE0 mode. Segment widths 340-3-LW, 340-3-RW, and 340-4-LW and 340-5-W may be any suitable widths that provide TE1 to TE0 mode conversion. In some embodiments, segment width 340-3-LW may be 0.5 to 1.5 um, while segment width 340-3-RW may be 0.4 to 1.0 um, segment width 340-4-LW may be 0.3 to 0.7 um, and segment width 340-4-RW may be 0.5 to 0.9 um. It should be appreciated that the gap between third segment 340-3 and fourth segment 340-4 over conversion region 360 may be any distance suitable that provides optical coupling.

Advantageously, the tapering of segments 340-3 and 340-4 may relax fabrication requirements. It should be appreciated that since the effective index of TE1 in segment 240-3 of FIG. 2 and TE0 in segment 240-4 of FIG. 2 should be the same, the waveguide gap and coupling length need to be accurately designed to get maximal transfer between TE1 and TE0. Referring to FIG. 3, as a result of the taper used in conversion region 360, the optical coupling length and gap has a larger tolerance as compared to conversion region 260 of FIG. 2 while still achieving comparable conversion and optical bandwidths.

It should be appreciated that if light is inputted via TM0 I/O 310 and outputted via TE0 I/O 390, TM0 to TE0 conversion takes place. Similarly, if light is inputted via TE0 I/O 390 and outputted via TM0 I/O 310, TE0 to TM0 conversion takes place.

It should be appreciated that since the lengths of segments 340 do not contribute to the polarization rotation, the lengths of each of segments 340 may be any suitable length.

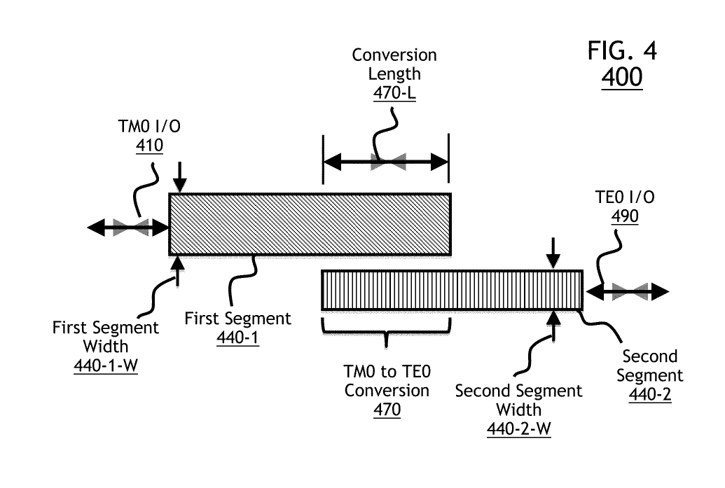

FIG. 4 depicts a block diagram of the top view 400 of a plurality of waveguide cores that is one embodiment of the top view of the plurality of waveguide cores 140-1 and 140-2 of FIG. 1. The plurality of waveguide cores includes a first waveguide core and a second waveguide core that are configured to achieve polarization rotation over an optical path (e.g., between TM0 I/O 410 and TE0 I/O 490). The first waveguide core includes segment 440-1 and the second waveguide core includes segment 440-2. In particular, segment widths 440-1-W and 440-2-W (collectively, segment widths 440-W) may be configured to achieve polarization rotation. In some embodiments, the plurality of waveguide cores is configured to convert light between fundamental TM0 and TE0 modes.

Polarization rotation occurs over conversion region 470. In conversion region 470, the effective index of TM0 for first segment 440-1 having a first segment width 440-1-W is substantially the same as that of TE0 for the second segment 440-2 having a second segment width 440-2-W. Conversion length 470-L may be configured to provide an optical coupling length that may achieve substantially 100% polarization conversion efficiency. Segment widths 440-1-W and 440-2-W and conversion length 470-L may be any suitable widths that provide TM0 to TE0 mode conversion. In some embodiments, segment width 440-1-W may be 0.5 to 1.5 um, while segment width 440-2-W may be 0.3 um to 1 um. It should be appreciated that the gap between first segment 440-1 and second segment 440-2 over conversion region 470 may be any distance suitable to provide optical coupling. It should be appreciated that due to high index contrast of segments 440 as compared to the top cladding (e.g., top cladding layer 120-t of FIG. 1), the TE0 and TM0 modes may be hybrid modes having both TE components and TM components providing a directional coupler over conversion region 470 that provides polarization rotation.

It should be appreciated that if light is inputted via TM0 I/O 410 and outputted via TE0 I/O 490, TM0 to TE0 conversion takes place. Similarly, if light is inputted via TE0 I/O 490 and outputted via TM0 I/O 410, TE0 to TM0 conversion takes place.

It should be appreciated that since the lengths of segments 440 outside of conversion region 470 do not contribute to the polarization rotation, the lengths of each of segments 440 outside of conversion region 470 may be any suitable length.

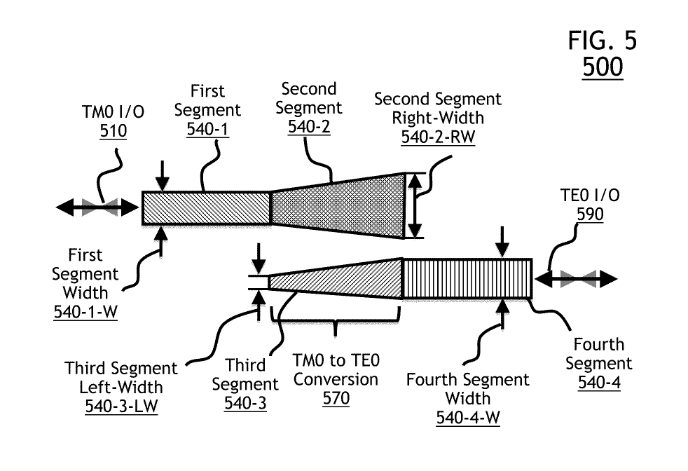

FIG. 5 depicts a block diagram of the top view 500 of a plurality of waveguide cores that is one embodiment of the top view of the plurality of waveguide cores 140-1 and 140-2 of FIG. 1. The plurality of waveguide cores includes a first waveguide core and a second waveguide core that are configured to achieve polarization rotation over an optical path (e.g., between TM0 I/O 510 and TE0 I/O 590). The first waveguide core includes two (2) segments: 540-1 and 540-2, and the second waveguide core includes two (2) segments: 540-3 and 540-4. In particular, segment widths 540-1-W, 540-2-RW, 540-3-LW and 540-4-W (collectively, segment widths 540-W) may be configured to achieve polarization rotation. In some embodiments, the plurality of waveguide cores is configured to convert light between fundamental TM and TE modes.

Polarization rotation occurs over conversion region 570 similar to as described for conversion region 470 in FIG. 4. Additional to first segment 440-1 and second segment 440-2 in FIG. 4, second segment 540-2 tapers between segment widths 540-1-W and 540-2-RW and third segment 540-3 tapers between segment widths 540-3-LW and 540-4-W to facilitate the optical coupling between TM0 and TE0. Advantageously, the use of tapers may relax the critical length requirement for the lengths of segments 440 in FIG. 2. In some embodiments, segment width 540-2-LW may be 0.5 to 1.2 um, segment width 540-2-RW may be 0.8 um to 1.5 um, segment width 540-3-LW may be 0.3 to 0.8 um, and segment width 540-2-RW may be 0.5 um to 1.0 um. It should be appreciated that the gap between second segment 540-2 and third segment 540-3 over conversion region 570 may be any distance suitable to provide optical coupling.

It should be appreciated that if light is inputted via TM0 I/O 510 and outputted via TE0 I/O 590, TM0 to TE0 conversion takes place. Similarly, if light is inputted via TE0 I/O 590 and outputted via TM0 I/O 510, TE0 to TM0 conversion takes place.

It should be appreciated that since the lengths of segments 540 do not contribute to the polarization rotation, the lengths of each of segments 540 may be any suitable length.

In some embodiments, the waveguide cores of FIGS. 2-5 may include addition segments (not shown for clarity). For example, in FIG. 2, a propagation segment that provides a propagation function may be included between second segment 240-2 and third segment 240-3.

Referring to FIG. 1a and FIGS. 2-5, in some embodiments, the slab extension width (e.g., slab extension width 130-W of FIG. 1a) is 0 for at least a portion of the waveguide core segments which realize TE1 and TE0 coupling (e.g., third segment 240-3 and fourth segment 240-4 of FIG. 2).

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

It should be appreciated that any block diagrams herein represent conceptual views of illustrative circuitry embodying the principles of the invention.

What is claimed is:

1. An apparatus for providing polarization rotation, the apparatus comprising:
a first cladding layer;
a slab including a first side and a second side, the first side disposed on the first cladding layer;
a plurality of waveguide cores contiguous to the slab, the plurality of waveguide cores being configured to convert light from a first light mode to a second different light mode over an optical path; and
a second cladding layer disposed on the second side and the slab;
wherein the first and second cladding layers comprise substantially the same material.

2. The apparatus of claim 1, wherein the slab is configured to have a slab extension width that is estimated to exceed waveguide mode.

3. The apparatus of claim 2, wherein the slab extension width is 0.05 um throughout at least a portion of the slab.

4. The apparatus of claim 1, wherein the slab is configured to have a slab extension width that completely separates the first cladding layer from the second cladding layer.

5. The apparatus of claim 1, wherein the slab and the at least one of the plurality of waveguide cores are at least a portion of a rib or ridge waveguide.

6. The apparatus of claim 1, wherein the first light mode comprises one of transverse electric dominated mode and transverse magnetic dominated mode and the second light mode comprises one of transverse electric dominated mode and transverse magnetic dominated mode.

7. The apparatus of claim 1, wherein the first and second cladding layers are substantially separated by the slab or waveguide.

8. The apparatus of claim 1, wherein the plurality of waveguide cores comprises:
a first waveguide core, the first waveguide core comprising:
a first segment, the first segment having a first segment width;
a third segment, the third segment having the third segment width; and
a second segment disposed between the first segment and the third segment, the second segment tapered between the first segment width and a third segment width; and
a second waveguide core optically coupled to the first waveguide core, the second waveguide core comprising:
a fourth segment, the fourth segment having a fourth segment width.

9. The apparatus of claim 8, wherein the third segment is optically coupled to the fourth segment.

10. The apparatus of claim 8, wherein the second segment is configured to convert light between TM0 and TE1 modes and the third segment and fourth segment are configured to convert light between TE1 and TE0 modes.

11. The apparatus of claim 1, wherein the plurality of waveguide cores comprises:
a first waveguide core, the first waveguide core comprising:
a first segment, the first segment having a first segment width;
a third segment, the third segment tapered between the third segment left width and a third segment right width; and
a second segment disposed between the first segment and the third segment, the second segment tapered between the first segment width and a third segment left width; and
a second waveguide core optically coupled to the first waveguide core, the second waveguide core comprising:
a fourth segment, the fourth segment tapered between a fourth segment left width and a fifth segment width; and
a fifth segment disposed further from the first waveguide core on the optical path as compared to the fourth segment, the fifth segment having the fifth segment width.

12. The apparatus of claim 11, wherein the third segment is optically coupled to the fourth segment.

13. The apparatus of claim 11, wherein the second segment is configured to convert light between TM0 and TE1 modes and the third segment and fourth segment are configured to convert light between TE1 and TE0 modes.

14. The apparatus of claim 1, wherein the plurality of waveguide cores comprises:
a first segment, the first segment having a first segment width; and
a second segment optically coupled to the first segment, the second segment having a second segment width.

15. The apparatus of claim 14, wherein the first segment and second segment are configured to convert light between TM0 and TE0 modes.

16. The apparatus of claim 1, wherein the plurality of waveguide cores comprises:
a first waveguide core, the first waveguide core comprising:
a first segment, the first segment having a first segment width; and
a second segment disposed closer to the second waveguide core on the optical path as compared to the first segment, the second segment tapered between the first segment width and a second segment right width; and
a second waveguide core optically coupled to the first waveguide core, the second waveguide core comprising:
a third segment, the third segment tapered between a third segment left width and a fourth segment width; and
a fourth segment disposed further from the first waveguide core on the optical path as compared to the third segment, the fourth segment having a fourth segment width.

17. The apparatus of claim 16, wherein the second segment is optically coupled to the third segment.

18. The apparatus of claim 16, wherein the second segment and third segment are configured to convert light between TM0 and TE0 modes.

19. An apparatus for providing polarization rotation, the apparatus comprising:
a first cladding layer;
a rib or ridge waveguide, the rib or ridge waveguide comprising:
a slab including a first side and a second side, the first side disposed on the first cladding layer; and
a plurality of waveguide cores contiguous to the slab, the plurality of waveguide cores configured to convert light from a first light mode to a second different light mode over an optical path; and
a second cladding layer disposed on the second side and the slab;
wherein the first light mode comprises one of transverse electric mode and transverse magnetic mode and the second light mode comprises one of transverse electric mode and transverse magnetic mode; and
wherein the first and second cladding layers comprise substantially the same material.
